(19) United States
(12) Patent Application Publication
(10) Pub. No.: US 2011/0103046 A1
(43) Pub. Date: May 5, 2011

(54) TRANSPORTABLE DEVICE WITH LEDS FOR EVENT AND STAGE LIGHTING

(76) Inventor: Julius Schrenk, Kreuzwertheim (DE)

(21) Appl. No.: 12/988,407

(22) PCT Filed: Apr. 20, 2009
(86) PCT No.: PCT/DE09/00501

§ 371 Date: Jan. 7, 2011

(30) Foreign Application Priority Data
Apr. 18, 2008 (DE) 10 2008 005 472.9

(51) Int. Cl. F21L 4/08

(52) U.S. Cl. 362/183

(57) ABSTRACT

The present invention relates to a device for illuminating in particular walls, facades, interior spaces and the like, comprising a housing, a reflector plate disposed in the housing, a lighting means having at least one LED, an electronic unit for actuating the lighting means, at least one control element for actuating the electronic unit, and a rechargeable self-contained power supply unit, wherein the reflector plate divides the housing into an upper part and a lower part, wherein the self-contained power supply unit and the electronic unit are disposed substantially beneath the reflector plate, and the control element and the lighting means are disposed on or in the reflector plate.

The present invention relates to a device for illuminating in particular walls, facades, interior spaces, stages and the like.

Lighting devices having different lighting modules are known for instance for utilization as garden lightings. In this regard, the additionally available lighting devices are supplied with electric power via a cable using a central energy supply element having an energy storage device and a solar cell. The additional lighting devices are spatially distributed depending on the length of the utilized cables in order to thus illuminate the gardens in a local fashion.

Furthermore, it is known from the state of the art to design a housing for LEDs (light-emitting diodes), wherein several LEDs are disposed on one base plate. Here, individual lenses are disposed above the LEDs and manipulate the generated light corresponding to a desired illumination purpose. The LEDs are disposed in depressions which are arranged on the base plate and which have the lenses installed above them so as to extend over the entire surface. The generated light is amplified by means of a reflective layer disposed in the depressions. The drawback of such lighting devices resides in the fact that a poor light emitting efficiency is obtained due to the small areas which are covered by a reflective layer. Besides, the firmly disposed optical elements in the form of lenses prevent a short-term exchange and consequently a rapid modification of the optical effects which can thereby be generated. Furthermore, problems are encountered in the attempt to attain maximum luminosity in order to be able to properly utilize the lighting devices for the illumination of large areas.

However, the known lighting devices in particular share the disadvantage that a necessary cabling gives rise to ponderous handling, in particular in instances where such lighting devices are employed in presentations, events, architectural lightings or on stages. This aspect renders assembly and disassembly expensive and also causes an increased risk of accidents due to the cables which are lying around.

Starting from this state of the art, it is an object of the present invention to create a lighting device which makes it possible to eliminate the cited disadvantages encountered in the state of the art.

This object is achieved by a device according to claim 1.

Preferred embodiments are the subject-matter of the subclaims.

The inventive device for illuminating in particular walls, facades, interior spaces, stages and the like features a housing, a reflector plate disposed in the housing, a lighting means having at least one LED, an electronic unit for actuating the lighting means, at least one control element for actuating the electronic unit, and a rechargeable self-contained power supply unit. In this regard, the reflector plate divides the housing into an upper part and a lower part, wherein the self-contained power supply unit and the electronic unit are disposed substantially beneath the reflector plate, and the control element and the lighting means are disposed on or in the reflector plate. This means that the entire lighting device can be utilized as one unit without any cable connection, whereby in particular a simple, uncomplicated and accident-proof assembly of a plurality of inventive lighting devices, for instance in the field of stages or events or in the illumination of architectural elements, can be realized. Due to the aspect that the entire main surface of the device is designed as a reflector plate, an increased light-emitting efficiency can also be obtained, in particular through the use of high-efficiency LEDs. In addition, the control elements are also disposed in the region of the reflector plate, so that the control elements are in each instance readily accessible in all working positions of the device, whereby an unambiguous and clearly laid-out configuration is additionally realized.

According to a preferred exemplary embodiment of the invention, provision is made for at least three lighting units. These lighting units can basically be disposed in any arbitrary fashion, for instance so as to be disposed linearly in succession, in a triangular, polyangular or circular fashion or else in the type of a regular or irregular matrix. The number and arrangement of the LEDs here is essentially contingent upon the desired degree of luminosity, the lighting effect and illumination.

The type of the LEDs is likewise basically arbitrary. Hence, the lighting devices may feature for instance white, colored or else color-changing LEDs, in particular in the form of RGB LEDs, or else may feature a combination of said LEDs.

In the simplest case, the LEDs of the inventive device can only be switched on or off. Preferably, however, the electronic unit features a memory-programmable control for actuating the lighting device, which can be programmed either indirectly via control elements which are disposed on the reflector plate or else directly, in particular via an external computer that can be connected via an interface. By means of this measure, it is easily possible to realize different degrees of luminosity, in particular by dimming or intensifying the light, or to realize color effects, for instance by means of color changes or color mixtures.

According to a particularly preferred exemplary embodiment of the invention, the electronic unit features a receiver for a remote control unit. By means of this measure, the desired lighting and color effects can be set by a user likewise from a distant position. The remote control unit here can be designed in the type of an infrared remote control or else a radio remote control, in particular according to DMX standard, which is widespread in particular in the field of event technology.

In particular if one of the inventive devices is supposed to be utilized as a master for a master-slave connection of several devices, according to another exemplary embodiment the device may feature a transmitter, in particular a radio transmitter according to DMX standard, for a remote control unit, and said radio transmitter transmits for instance the control signals received by the remote control of a user to the slave units, whereby a synchronization of a plurality of inventive devices can be realized.

According to another exemplary embodiment, the inventive device features at least one female or male connector, which is preferentially disposed in the reflector plate and by means of which at least two inventive devices can be electrically coupled. In this way, a plurality of devices can equally be coupled and thus be synchronized.

According to another exemplary embodiment, the inventive device features at least one display device disposed at or in the reflector plate, in particular in the form of at least one signal lamp or a LCD display for displaying electrical and/or logical operating states of the device. In this regard, switching states (on or off), operating states (color changer, colors etc.) or the charging state of the accumulator can be displayed in any arbitrary fashion.

The LEDs employed in the inventive device merely feature one emission characteristic, in particular emission angle, which is related to the type of construction. In order to provide more options for modifying the lighting effect, according to another particularly preferred exemplary embodiment of the invention, at least one device is provided for manipulating the optical path of the light emitted from the lighting device.

This device can be firmly or preferably removably disposed at the housing or the reflector plate. In order to be able in particular to perform a simple and rapid exchange of the device, according to another exemplary embodiment, the reflector plate and/or the housing feature/s recesses for the passage of closure elements of a quick fastener, which are disposed at the device.

A first exemplary embodiment of a device for manipulating the optical path features at least one optical plate, in particular having lens elements. Said lens elements here can be designed for instance as collective lenses, diffusing lenses or patterned lenses. The type of arrangement of the optical plate on the reflector plate is basically arbitrary. Thus, the optical plate may directly abut on the reflector plate or else may face the reflector plate at a slight distance therefrom, for instance using spacers or the like.

As an alternative or also in addition to optical plates in the form of light shapers, according to another exemplary embodiment, a device may be used, which features at least one mirror arrangement for deflecting the light. In this context, the mirror arrangement may feature a motor drive for pivoting the mirror, so that an illumination effect in the type of a “moving head” known from stage technology can be realized.

A particularly preferred embodiment of an inventive device can be implemented if the housing is designed as a “case” known per se from event technology and features a cap, which can be removably attached at the housing via closure means. Thus, the housing of the device simultaneously serves as a transport housing, wherein in addition the sensitive region of the reflector plate is covered by the cap during transport.

According to the invention, the power supply is realized via a rechargeable self-contained power supply unit, i.e. an accumulator. For the purpose of performing the charging, said accumulator for instance can be removed from the housing. According to another exemplary embodiment, however, in the region of its bottom or on one of its lateral walls, the housing features a female connector or a contact area for connecting a male connector being complementary thereto, or features a contact area of a charging device. In the simplest case, as is known from a plurality of accumulator-driven devices, the charging plug of an external charging device can be inserted into the female connector of the housing, which is complementary thereto. A particularly preferred embodiment, however, can be realized if the male connector, the female connector or the contact area of the housing is designed in such a manner that a current-conducting connection is established if the inventive device is placed into a transport box, which has connecting elements being complementary in shape and function. In this way, for instance a plurality of inventive devices for charging and for transport can be placed into a larger transport box, wherein only the charging device of the transport box then needs to be connected to the power supply system.

According to another exemplary embodiment, a further option of lighting configuration can be realized by the aspect that on its lower side, the housing features a device for height adjustment or inclination of the housing. This can be performed for instance by a foldable inclinator or by the aspect that among the feet which are arranged at the bottom of the housing at least one can be adjusted in its height, for instance in the type of a screwed foot.

According to another exemplary embodiment, a modification in the lighting configuration can be realized in that the reflector plate is inclinably disposed in the housing.

Hereinafter, the invention will be described in greater detail with reference to the drawings which only illustrate an exemplary embodiment.

In the drawings:

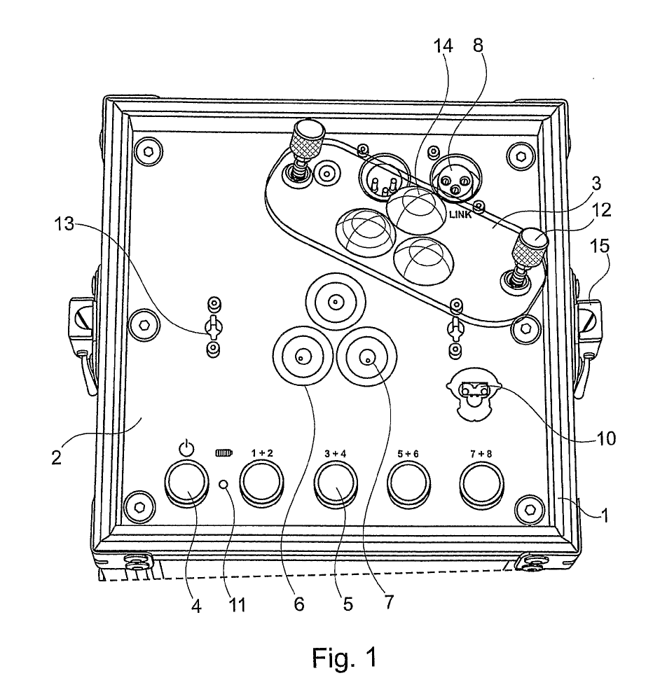

FIG. 1 shows a plan view of the lighting device having the optical plate removed;

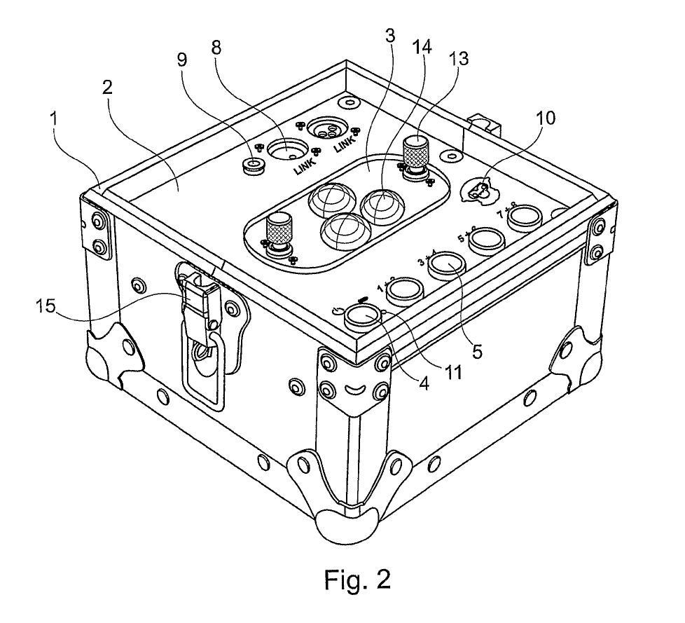

FIG. 2 shows a perspective view of a lighting device having the optical plate mounted thereon;

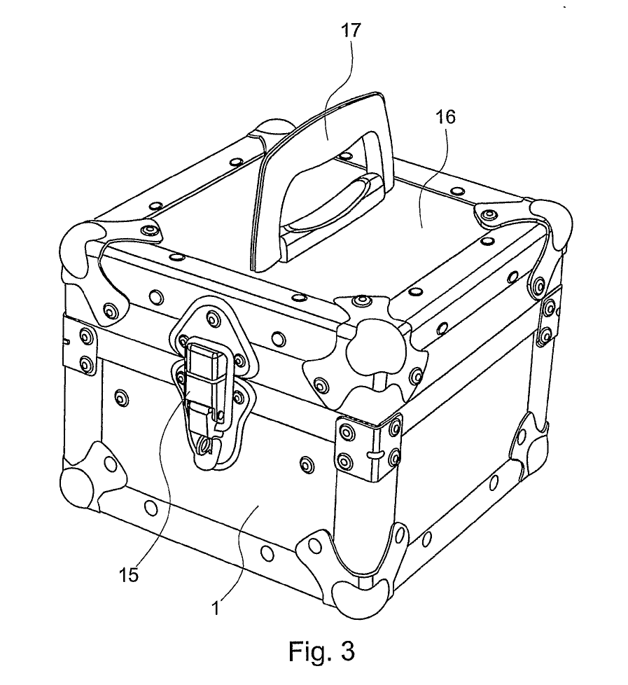

FIG. 3 shows a perspective view of a lighting device having a closed cap.

FIG. 1 shows an inventive lighting device comprising a housing 1 and a reflector plate 2, which, in an initially loose fashion, has an optical plate 3 arranged thereon. On the reflector plate 2, provision is made for control elements comprising a power switch 4 and further program buttons 5, which are arranged in a row and which are here exemplarily designed as push buttons for the selection of respectively two program items. In the center of the reflector plate 2, three depressions 6 are disposed so as to form a triangle, in which respectively one lighting means 7 in the form of an RGB LED is arranged. In the upper region of the reflector plate, different recesses are provided for different terminals with two terminals of a complementary design for the connection of further lighting devices with a combined terminal 8 and a further terminal being laterally disposed thereto and which is designed as a power connector 9. Beneath the logo on the right-hand side of the reflector plate 2, an infrared sensor 10 is disposed beneath a corresponding recess, and between the control elements, provision is made for another small region which does not feature a reflective layer, in order to visibly arrange a battery display 11 disposed therebeneath.

The optical plate 3, which is disposed on the reflector plate 2 in an unfixed manner, in the edge region thereof features fastening elements 12 in the type of a quick fastener, which are provided on the reflector plate 2 for fastening the optical plate in the retainer elements 13. The optical plate 3 is made of a transparent material and in its center features three lenses 14 which are adhesively bonded into the optical plate so as to be transparent. Moreover, a closure means 15 for fastening the cap is discernible.

In FIG. 2, the reflector plate 2 is arranged in the housing 1 and has the optical plate 3 connected thereto using fastening elements 13. The optical plate 3 in its center features three lenses 14, which are situated above the lighting means (here invisible). Moreover, the control elements having the power switch 4 and the program switches 5 are discernible in the lower region of the reflector plate. The terminals for a computer or further lighting modules having the combined terminal 8 are discernible in the upper region of the reflector plate 2 adjacent to the terminal for a power supply unit 9. The further regions, which do not feature a reflective layer, on the one hand are arranged in the region of the logo above an infrared sensor 10 and in addition are arranged in the region between the program keys and the power switch, respectively, above the charging indicator lamp for the accumulator 11.

For closure using a cap, the housing 1 features closure means 15 on two opposing sides, which only by way of example are here designed with a clamping bracket.

FIG. 3 shows the device in a closed state for transport. For this purpose, a cap 16 is disposed on a housing 1. The cap 16 features a handle 17 for ease of transport. In order to firmly connect the housing 1 with the cap 16, a closure means 15 is utilized. For enabling closure, the cap is mounted thereon and a bracket is hinged at a corresponding fixture of the cap and said bracket is clamped to a counter-retainer at the housing.

The invention thus makes an essential contribution to the improvement of lighting devices, in particular since a compact and readily transportable device is suggested, which utilizes the reflector as a central element in order to thus realize markedly enhanced light-emission efficiency and to consequently ensure a clearly laid-out operation. Thus, not only an enhancement in terms of the light-emitting efficiency and ease of operation, but also an enhancement in terms of the modular utilization of a lighting device can be realized.

1. Device for illuminating in particular walls, facades, interior spaces, stages and the like, comprising a housing, a reflector plate disposed in the housing, a lighting means having at least one LED, an electronic unit for actuating the lighting means, at least one control element for actuating the electronic unit, and a rechargeable self-contained power supply unit, wherein the reflector plate divides the housing into an upper part and a lower part, wherein the self-contained power supply unit and the electronic unit are disposed substantially beneath the reflector plate, and the control element and the lighting means are disposed on or in the reflector plate.

2. Device according to claim 1,
characterized in that
at least three lighting units are provided, which are arranged in a linear, triangular, quadrangular, polyangular or circular fashion or else in the type of a regular or irregular matrix.

3. Device according to claim 1 or 2,
characterized in that
the LEDs of the lighting means feature white, colored or color-changing LEDs, in particular in the form of RGB LEDs.

4. Device according to any of claims 1 to 3,
characterized in that
the electronic unit features a memory-programmable control for actuating the lighting means, which can be programmed either directly via control elements that are disposed on the reflector plate or else indirectly, in particular via an external computer that can be connected via an interface.

5. Device according to any of claims 1 to 4,
characterized in that
the electronic unit features a receiver for a remote control unit.

6. Device according to claim 5,
characterized in that
the remote control unit is designed either in the type of an infrared remote control or a radio remote control, in particular according to DMX standard.

7. Device according to claim 5 or 6,
characterized in that
the electronic unit features a transmitter, in particular a radio transmitter according to DMX standard, for a remote control unit.

8. Device according to any of claims 1 to 7,
characterized by
at least one female or male connector which is preferentially disposed in the reflector plate and by means of which at least two inventive devices can be electrically coupled.

9. Device according to any of claims 1 to 8,
characterized in that
at least one display device, in particular in the form of at least one signal lamp or an LCD display, is disposed at or in the reflector plate for displaying electrical and/or logical operating states of the device.

10. Device according to any of claims 1 to 9,
characterized by
at least one device for manipulating the optical path of the light that is emitted from the lighting means.

11. Device according to claim 10,
characterized in that
the device is removably disposed at the housing or the reflector plate.

12. Device according to claim 11,
characterized in that
the reflector plate and/or the housing features recesses for the passage of closure elements of a quick fastener, which are disposed at the device.

13. Device according to any of claims 10 to 12,
characterized in that
the device features at least one optical plate, in particular having lens elements, which can be disposed directly on the reflector plate or at least at a slight distance from the reflector plate.

14. Device according to any of claims 10 to 13,
characterized in that
the device features at least one mirror arrangement for deflecting the light.

15. Device according to claim 14,
characterized in that
the mirror arrangement features a motor drive for pivoting the mirror.

16. Device according to any of claims 1 to 15,
characterized in that
the housing is designed as a case and has a cap that is removably attachable at the housing via closing means.

17. Device according to any of claims 1 to 16,
characterized in that
in the region of its bottom or one of its lateral walls, the housing features a female connector or a contact area for connecting a male connector being complementary thereto, or features a contact area of a charging device.

18. Device according to any of claims 1 to 17,
characterized in that
on its lower side, the housing features a device for height adjustment or inclination of the housing.

19. Device according to any of claims 1 to 18,
characterized in that
the reflector plate is inclinably or else pivotably disposed in the housing.
